(19) United States
(12) Patent Application Publication
(10) Pub. No.: US 2021/0333532 A1
(43) Pub. Date: Oct. 28, 2021

(54) A LIGHT SOURCE APPARATUS

(71) Applicant: COOLLED LTD., Andover (GB)

(72) Inventors: Gerry WHORISKEY, Andover (GB); Christopher EGGINGTON, Andover (GB); Joshua GREENAWAY, Andover (GB); Jinting GUO, Andover (GB); Luther HINDLEY, Andover (GB); Andrew TURNBULL, Andover (GB)

(73) Assignee: COOLLED LTD., Andover (GB)

(21) Appl. No.: 17/272,333

(22) PCT Filed: Aug. 29, 2019
(86) PCT No.: PCT/GB2019/052408

§ 371 Date: Feb. 28, 2021

(30) Foreign Application Priority Data
Aug. 31, 2018 (GB) 1814228.1

(51) Int. Cl. G02B 21/16; F21V 23/00; F21V 9/20; F21V 19/00; F21S 2/00

(52) U.S. Cl. CPC G02B 21/16; F21V 23/003; F21Y 2115/10; F21V 19/0035; F21S 2/005; F21V 9/20

(57) ABSTRACT

Disclosed herein is a light source apparatus for providing an adjustable number of wavelength channels. The light source apparatus comprises at least a first plurality of LED modules, each LED module comprising an LED, a housing which at least partially encloses the LED, and a light director attachable to said housing for directing light emitted by the LED. The first plurality of LED modules are attached to a support structure in a first arrangement via attachment means. In the first arrangement, light emitted by each LED of the first plurality of LEDs is directed along a first optical axis. At least one LED module of the first plurality of LED modules is a removable LED module, and the attachment means is configured to allow the removal and re-attachment of the removable LED module to and from the first arrangement. The light source apparatus further comprises a plurality of driver PCBs and a controller PCB, each driver PCB of the plurality of driver PCBs being coupled to the controller PCB, and each LED module of the first plurality of LED modules is coupled to a first driver PCB of the plurality of driver PCBs. The controller PCB is configured to provide control signals to each of the driver PCBs, and each driver PCB is configured to provide drive signals to any LED module coupled with it.

This disclosure relates to a light source apparatus, and in particular this disclosure relates to a light source apparatus comprising LEDS which is suitable for use in the field of fluorescence microscopy.

### BACKGROUND

Fluorescence microscopy can be broadly described as the study of the properties of a fluorescent material. Fluorescent fluorophores sometimes referred to as probes or dyes can be used to tag specific parts of cells or material. In a typical arrangement, a living or fixed biological sample, or a material sample, is viewed using an optical microscope. Light of a specific wavelength or wavelength region is projected onto the sample. The fluorophore within the sample absorbs the excitation light, and light is subsequently emitted from the fluorophore at a longer wavelength through a mechanism known as the Stokes Shift. The regions of the sample which emit light in this way may be imaged by a microscope.

Different bands of the electromagnetic spectrum may be used as the excitation light, depending on the application. Illuminating the sample with multiple spectrally separate and bandwidth limited regions results in a number of spectrally separate wavelength emission regions from the sample. Imaging these separate emission regions can provide multicolour images that differentiate parts of the sample with good contrast for research or diagnostic purposes. This technique is widely used in Life Sciences research and High Content Screening (HCS) applications.

Traditionally fluorescence microscopy has been served by a single broad-spectrum bulb-based source. Examples are the mercury bulb, the metal halide bulb and the xenon bulb. These sources provide a broad ‘white’ light like spectrum from a single high intensity arc between two electrodes. To be useful in fluorescence microscopy these bulbs have to have their wide spectral output filtered by high quality and expensive narrowband excitation filters. Out-of-band blocking from these filters is required to suppress unwanted wavelengths that would add noise to the fluorescent image. In order to capture high speed live cell images, the excitation filtering mechanism must move at high speed to provide different excitation wavelengths for multicolour images. This requires the excitation filters to be mounted in high speed filter wheels. High speed shutters are also required with bulb based light sources as switching on and off is detrimental to the bulb lifetime and light exposure to the sample must be tightly controlled to reduce photobleaching and phototoxic effects.

Unlike bulb based light sources, LEDs provide a narrow bandwidth of light at specific spectral regions. When chosen correctly LEDs can match the fluorophore absorption peak precisely and have very low levels of energy outside the region of interest thus requiring less filtering. However, one drawback to using LEDs in place of bulb-based sources is that multiple LEDs are needed to cover the required spectrum. Using arrangements known in the prior art, this adds significant optical, mechanical and electronic complexity, and so cost, to LED based sources for fluorescence.

Fluorescence microscopy applications typically require light at different wavelengths to be incident on the sample. The required number of wavelengths for a given application varies. For example, some applications such as tuberculosis (TB) detection may only require a single wavelength, ratio metric calcium imaging as done using Fura-2 requires 2 distinct wavelengths, and fluorescence in-situ hybridisation (FISH) techniques may require 5 or more wavelengths regions. The actual number of required channels can vary depending on the specifics of the application. New probes or fluorophores that attach to target regions of the cells and absorb and reemit light are always emerging, sometimes at non-typical spectral regions or even broadening the typical spectral range used.

It is beneficial for the light source apparatuses in multiuser labs, sometimes referred to as ‘core facilities’ to have a large number of wavelength channels because such light source apparatuses must cater for the needs of many researchers in wide-ranging and disparate fields, who each must book time on the shared light source apparatus and microscope.

There are LED systems on the market with a fixed number of channels, for example 6 or 8 channel systems. They offer a compromise of wavelengths and spectral coverage for standard fluorescence work. However, in prior devices it has not been possible to swap LED channels in and out, or increase the number of LED channels, because any additionally added LED channels must fit within the strict wavelength combining rules imposed by the particular DM arrangement.

An end user who wishes to study a particular application requiring the use of an excitation wavelength which cannot be provided by their LED light source product is currently faced with a number of unsatisfactory options. They may return to using an appropriately filtered xenon or mercury bulb and accept the flaws and disadvantages associated with such light sources. They may buy another, completely different LED-based product which provides for their desired wavelength. Alternatively, they may approach the manufacturer of their existing product and ask whether an additional wavelength channel can be added to their existing product. However, adding or removing a wavelength channel in known arrangements would require the manufacturer to design and construct a new custom arrangement. The complicated arrangement of power supply, control and drive electronics and optics must be reconsidered and redesigned. The space envelope provided by the product casing must be considered, as adding LEDs, and the associated additional electronics and optics, to known LED light source arrangements typically causes them to become too large to fit inside their previous casing. Therefore, this last option of adding a wavelength channel to an existing light source product is prohibitively expensive and excessively complicated for manufacturers.

Another issue to the manufacturer of LED light sources is the growing requirement in fluorescence microscopy for new wavelengths and more wavelengths. This fact will continue to drive up demand on the number of LED wavelengths available in a single fixed channel system. This has forced manufacturers to make a decision on what wavelengths and how many wavelengths to offer. A system that attempts to be futureproof by providing 12 or 16 wavelengths will be costly and prohibitively expensive for many users. As LED light sources are based on multiple discreet wavelengths that must be combined into a single optical output the costs escalate with the number of channels offered. Each channel requires its own drive electronics for independent wavelength control and its own collimating lenses. In the most common arrangement wavelengths are combined using DMs, the number of DMs being one less than the number of channels being combined.

The present invention seeks to address these and other disadvantages encountered in the prior art by providing a modular and scalable platform, mechanically, electronically and optically for manufactures of light sources for fluorescence microscopy. The platform described will enable manufacturers to produce a wide variety of dedicated application specific products with a variety of wavelength options in a single dedicated unit. The wavelength compromise problem can be dramatically reduced, product updates with more wavelengths when needed will be simpler and require minimal design time and a more appropriate cost assigned to the particular application need will be met.

### SUMMARY

An invention is set out in the independent claims. Optional features are set out in the dependent claims.

According to an aspect, a light source apparatus for providing an adjustable number of wavelength channels is disclosed. The light source apparatus comprises at least a first plurality of LED modules, each respective LED module comprising a housing which at least partially encloses an LED, and a light director attachable to said housing for directing light emitted by the LED. The first plurality of LED modules is attached to a support structure in a first arrangement via attachment means. In the first arrangement, light emitted by each LED is directed along a first optical axis. The light source apparatus further comprises a plurality of driver PCBs including a first driver PCB, each driver PCB being configured to provide drive signals to any LED modules coupled with it. Each LED module of the first plurality of LED modules is coupled with the first driver PCB. Each driver PCB of the plurality of driver PCBs is coupled to a controller PCB, the controller PCB being configured to provide control signals to each of the driver PCBs.

At least one LED module of the first plurality of LED modules may be a removable LED module, and the attachment means may be configured to allow the removal and re-attachment of the removable LED module to and from the first arrangement.

### FIGURES

Specific embodiments are now described, by way of example only, with reference to the drawings, in which:

FIG. 1a depicts an LED module according to the present disclosure;

FIG. 1b is a cross-sectional schematic of the LED module of FIG. 1a;

FIG. 1c shows a substrate of an LED module according to the present disclosure;

FIG. 1d shows a substrate attached to an LED module in accordance with the present disclosure;

FIGS. 2a and 2b are cross-sectional schematics of light source apparatuses according to the present disclosure;

FIG. 3 depicts a light source apparatus according to the present disclosure with a first plurality of stacked LED modules;

FIGS. 4a and 4b are schematics of light source apparatuses according to the present disclosure;

FIG. 5 depicts a light source apparatus according to the present disclosure with multiple pluralities of stacked LED modules;

FIG. 6 shows electronic components and features of a controller according to the present disclosure;

FIG. 7 shows electronic components and features of a driver according to the present disclosure;

FIG. 8 shows the reflection and transmission properties of a dichromatic mirror according to the present disclosure;

FIG. 9 shows an extrusion suitable for forming an LED module of the present disclosure;

FIG. 10 depicts part of a manufacturing process for producing an LED module according to the present disclosure.

### DETAILED DESCRIPTION

### Structure of a Single LED Module

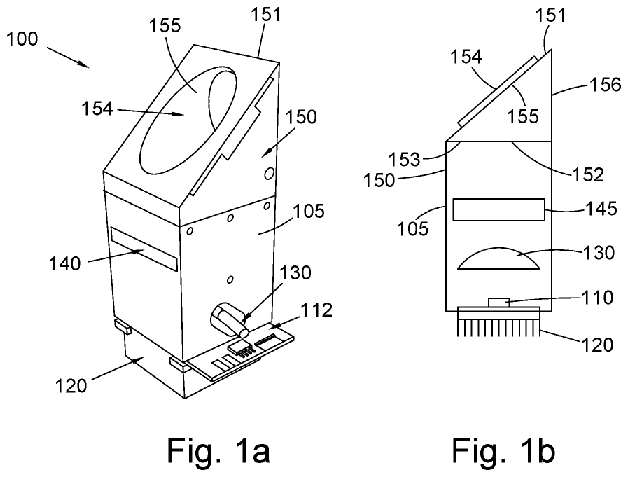

FIG. 1 depicts an LED module 100 according to the present disclosure. FIG. 1b is a schematic cross-section of the LED module shown in FIG. 1a, showing the components housed within the LED module 100. Like reference numerals are used to indicate corresponding features in FIGS. 1a and 1b.

The LED module 100 comprises a primary block 105 and a detachable dichromatic mirror (DM) block 150. In FIGS. 1a and 1b, the primary block 105 and the detachable block 150 are coupled together to form a housing. The primary block 105 and the detachable DM block 150 may thus be termed first and second housing components. To form the housing, the blocks are detachably coupled, in other words removably coupled, to one another. Both the primary block 105 and the DM block 150 are at least partly hollow. The primary block 105 has a central bore running throughout its entire length. The bore may be cylindrical or may have any other suitable cross-section. The DM block 150 may be detached from the primary block 105. The DM block 150 and primary block 105 may be attached together using a suitable arrangement of tapped holes and screws. Locating grooves and ridges may also be provided on each of the primary block 105 and the DM block 150 to ensure alignment. The primary block 105 is hollow to allow optical components to be housed therein.

Both the DM block 150 and primary block 105 comprise tapped holes locations in positions which allow the blocks to be screwed together into the arrangement shown in FIGS. 1a and 1b. This allows the housing to be easily assembled and disassembled. The LED modules also comprise attachment means configured to allow the LED module to be attached to a support structure. The support structure may be sized and configured to allow the attachment of a plurality of LED modules, for example in a particular arrangement, as will be discussed in further detail herein. The DM block 150 and primary block 105 comprise the attachment means, which may take a number of forms for example tapped holes located in extensions from the main body of the blocks (105, 150), which allow both blocks to be attached to, e.g. screwed to, the support structure. The LED module can thus be attached to support structure by screwing the module to the support structure using screws and appropriately sized and located tapped holes in the LED module housing and the support structure. The attachment means may additionally or alternatively comprise guiding and interlocking grooves and ridges located on the LED module and support means, a ‘click-and-connect’ arrangement, and/or a bayonet mount and attachment.

The primary block 105 comprises a light-emitting diode (LED) 110, a substrate 112, a heat sink 120, a light collector 130 such as a lens, and a slot 140 for receiving a filter 145 such as an excitation filter. These components are arranged inside the primary block 105 in a generally columnar arrangement. The detachable DM block 150 comprises three apertures (152, 155, 156), with one of the apertures 155 being covered at least partially by a dichromatic mirror 154. The LED module 100 and its constituent components are arranged and configured such that light emitted by the LED 110 passes through the hollow region of the primary block 105, through any intervening optics and filters, and through a first aperture 152 of the DM block 150 into the hollow region of the DM block 150. Light entering the DM block 150 from the first aperture 152 is incident on the dichromatic mirror 154, and is reflected out of the LED module 100 through a third aperture 156 in the DM block 150.

The LED module 100 comprises an LED 110 placed on a substrate 112. The LED 110 is placed centrally on the substrate 112. Any suitable LED may be used, and the skilled person will appreciate that a range of design options, for example, semiconductor materials and doping concentrations, allow the production of LEDS which emit light at a preferred wavelength from a wide variety of available wavelengths from example from the UV to IR. In a preferred embodiment, the LED 110 emits light from its top surface and is of the vertical conduction design type. In this preferred embodiment, the LED 110 has no encapsulation lens. The absence of an integrated lens simplifies the optical design and the vertical conduction type simplifies the electrical interconnections required, as well as providing for improved the thermal management. Other types of LED types may be used, for example LEDs with integrated lens, horizontal conduction types, edge emitting LEDs, super-luminescent LEDs, or laser diodes.

The LED module 100 also comprises a light collector 130, for example a lens or a plurality of lenses. The light collector 130 is inserted into an annular groove or slot which runs around an inner circumference of the bore of the primary block 150. The groove or slot holds the lens in place inside the primary block 130 (or housing). It will be understood that multiple grooves or slots may be provided to hold a plurality of lenses in place in embodiments where the light collector 130 comprises a plurality of lenses. The light collector 130 may also comprise compound lenses. The light collector may act to collimate light emitted by the LED. LEDs typically emit light in a Lambertian profile. In a preferred embodiment, the light collector 130 comprises two collector lenses which act to collimate the divergent light that is emitted from the LED surface.

The light collector can be adjusted by mechanical means 132, for example a lever which extends from an outer wall of the LED module. The lever is coupled to the light collector 130 in a manner such that manipulation of the lever adjusts the light collector 130. The mechanical means 132 allows the focus of the light collector 130 to be adjusted. In the preferred embodiment the mechanical means 132 may comprise a simple slot and lever/handle on the side of the module block which allows the position of the two collector lenses relative to the LED surface to be adjusted. In this manner, any mechanical differences due to tolerancing and different LED heights may be accounted for. Allowing the collector lenses to be adjusted in this manner is also important because it allows the different optical path lengths that may occur in such a scalable modular system to be accommodated for. The mechanical means, or mechanical adjustment means 132, also allows output image positions to be controlled without the need for chromatically correct output optics.

The LED module 100 also comprises a slot 140 which allows insertion of the excitation filter 145 into the bore of the primary block 105. The slot 140 also allows the excitation filter 145 to be removed from the bore. The filter may be a monochromator, i.e. a type of filter used to isolate a particular wavelength of light, or a bandpass filter, which passes a range of wavelengths. The excitation filter 145 used will typically vary depending on the application. For example, if the sample has been treated using a fluorescent dye, the excitation filter 145 may be chosen so as to pass only wavelengths which will be absorbed by the dye or which closely matches the peak of the dye absorption.

The LED module 100 may comprise a slideable shelf or ‘slider’ which is shaped, sized and configured to be inserted into the slot 140. The slideable shelf is configured to hold a filter and can be slid out from, and back into, the bore of the LED module 100. This slider will allow the user or manufacturer to insert, remove and swap in any standard sized excitation filter according to the application. The inner surfaces of the LED module 100 in the vicinity of the slot 140 may comprise a ridge or groove to allow the slideable shelf to be easily slid into and out from the housing.

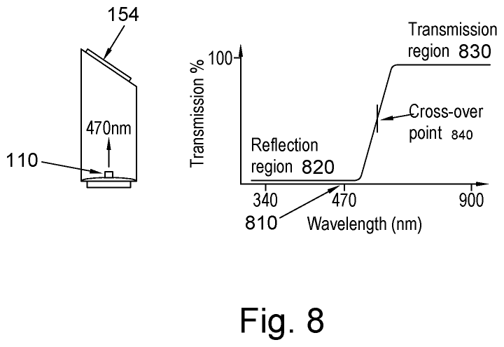

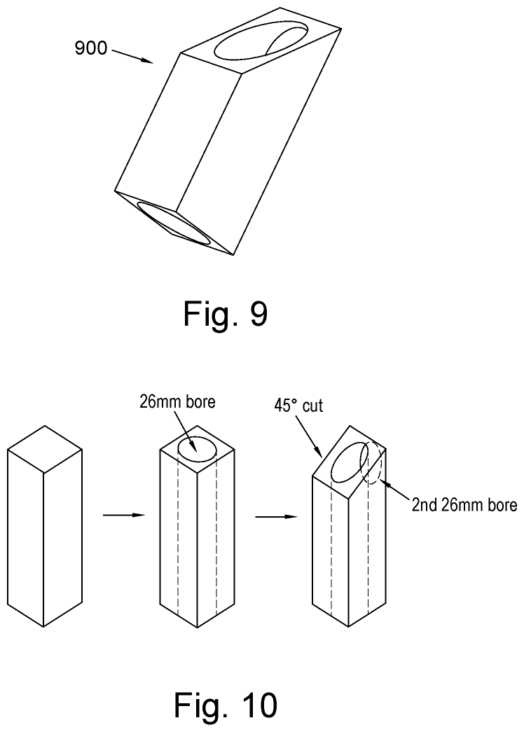

The LED module 100 further comprises a dichromatic mirror block, or DM block, 150. The bottom surface of the DM block 150 forms an interface with the top surface of the primary block 105. The blocks meet so that their surfaces are flush; in other words, so that the respective outer surfaces of the blocks meet evenly. In a preferred embodiment, the primary block 105 is a square prism, and the DM block 150 is a triangular based prism. The upper square face of the primary block 105 meets a corresponding lower square base of the DM block 150. As detailed in further detail below with reference to FIGS. 9 and 10, the primary block 105 and the DM block 150 may be fabricated by taking a metal extrusion shaped as a square prism, forming a hollow bore through the length of the prism, cutting the extrusion at a 45° angle, and then cutting through the extrusion to form a square based and a triangular based prism. It will be appreciated that a DM block and a primary block fabricated in this manner have the shapes depicted in FIGS. 1a and 1b.

The DM block 150 is substantially shaped as a triangular prism, and has a square base 153 and an upper angled face 151. The square base 153 is arranged to meet an upper face of the primary block 105. The DM block 150 has a central hollow region and a plurality of apertures which allow light to pass into and out from the interior hollow region. The apertures are located on each of the rectangular or square faces of the DM block 150. The first aperture, 152, is on the bottom face of the DM block 150. When the DM block 150 is coupled to the primary block 105, the first aperture 152 is aligned with the bore of the primary block 105, and hence aligned with the arrangement of optics comprised within the primary block 105. This arrangement allows light emitted by the LED 110 to pass from the primary block 105 into the DM block 150.

The light director 154 may be a dichromatic mirror or long-pass filter. The light director may comprise a dielectric material. The light director may be formed using a non-dielectric film coating method according to known methods.

Depending on preferred terminology, the dichromatic mirror may also be called a dichroic mirror or dichroic filter. The DM 154 is configured to pass light of certain wavelengths, and reflect light of certain other wavelengths. The DM 154 is chosen to have reflection and transmission properties such that light emitted by the LED 110 is reflected by the DM 154. The upper face 151 of the DM block 150 is arranged at an angle to the base of the DM block 150. Preferably, the angle is substantially 45°. Even more preferably, the angle is 45°. Equivalently, the upper face 151 is arranged at an angle of substantially 45° to the central axis of the bore of the primary block 105. In other words, the upper face 151 is arranged at an angle to the direction of light incident on the DM 154.

The DM 154 is positioned at an angle to the LED light incident on the DM 154, and has properties which cause reflection of the wavelength band emitted by the LED and/or passed by the excitation filter. Consequently, light emitted by the LED 110 is incident on the DM 150 and is reflected out of the LED module 100, and the DM block is arranged and configured such that the reflected light passes through a third aperture 156 in the DM block 150. The third aperture 156 of the DM block 150 faces the second aperture 155. Reflected light exits the LED module 100 through the third aperture.

The DM block 150 further comprises a second aperture 155. The second aperture 155 is located in the upper angled face 151 of the DM block 150. The DM 154 at least partly covers the second aperture 155. The DM 154 lies flat against an upper face of the DM block 150, and hence flat against the second aperture 152. In a preferred embodiment the DM 154 rests flat against the outside of the upper angled face 151, which allows for easy assembly and removal of the DM 154 if needed. The DM 154 sits in a recess machined into the angled face 151 (not shown in the figures) and is held in place with a transparent plastic which may be clipped onto the DM block 150 (not shown in the figures). Alternatively, the DM 154 may be attached to the DM block 150 in other ways; for example, the DM 154 can be simply glued into place. In this way the light director/DM is attached to the housing.

The substrate 112 is positioned at, and attached to, the base of the primary block 105 such that the LED 110 is located centrally within the bore of the primary block 105. The substrate 112 and LED 110 are located and positioned in a manner which allows light emitted by the LED to travel substantially along a central axis of the bore. The arrangement and configuration of the substrate 112 and its attachment to the bottom surface of the primary block 105 can be better appreciated by inspection of FIGS. 1c and 1d.

The substrate 112 comprises at least one dielectric layer placed on top of a substrate base. The substrate 112 may contain multiple dielectric layers. The dielectric layer contains conductive tracks which allow the LED 110 to be electrically coupled to power and control electronics 113. The tracks may be made of copper or another conductive material. The substrate base is preferably made of a good thermal conductor such as copper. This allows the substrate 112 to effectively conduct heat away from the LED 110 and its associated electronics. The conductive tracks provide power to the LED 110 and the LED module 100 can thus be connected to an external power supply.

The substrate 112 connects electrically to a driver PCB. A controller PCB delivers current and communication signals to the driver PCB. The driver PCB, controller PCB and associated electronics are discussed in greater detail elsewhere herein. The controller PCB gets its power from an external power supply. A cable 114 electrically connects the LED module 100 with the driver PCB. The cable 114, for example a ribbon cable, accommodates the control signals whilst wires, for example the two copper wires 115 depicted in FIGS. 1c and 1d, deliver the power to drive the LED 110. The cable attaches to the copper substrate 112 on each LED module 100.

The substrate electronics/control electronics 113 may comprise a number of components, some of which will now be detailed. The substrate electronics comprise a small chip or other computer readable medium/memory, for example an EEPROM chip, for holding information about the LED such as peak wavelength, drive current and lifetime. The controller PCB is configured to read this information from the chip. The LED module can therefore be automatically recognised once it is plugged in/coupled to the controller PCB.

As connectors on the driver PCB will be positioned next to attached modules, the CPU on the controller board will also be able to determine the position of each LED relative to one another. Therefore information regarding the arrangement, for example whether the arrangement is correct or incorrect according to the arrangement rules set out elsewhere herein, can be relayed to the user. As will be explained, the transmission and reflection properties of the dichromatic mirrors of each LED of the arrangement may be different, and the LED modules must be ordered such that light from each LED of the arrangement can pass through any dichromatic mirrors which are placed in an optical path between the LED module and the output module of the light source apparatus. The information may be outputted, i.e. relayed, to the user in a number of different ways, for example through a PC program that the controller communicates with, on a dedicated display screen, or through an arrangement of simple LEDs (e.g. a green LED indicates that the LED modules are arranged in a correct order and a red LED indicates that the modules are arranged in an incorrect order).

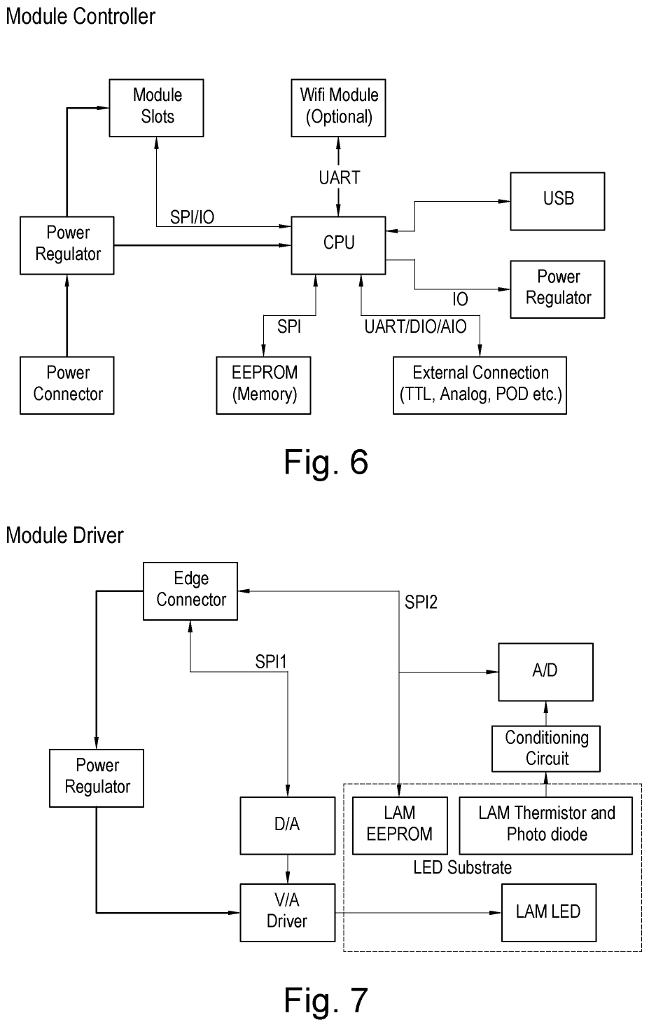

The transmission and reflection properties of a dichromatic mirror according to this arrangement are depicted in FIG. 8. The LED 110 of the LED module depicted in FIG. 8 emits light at an emission wavelength 810, in the depicted example the emission wavelength is equal to or substantially equal to 470 nm. The DM block of the LED module comprises a dichroic mirror 154 having the transmission properties depicted in the graph. The graph shows percentage transmission as a function of wavelength. As will be appreciated, the LED emission wavelength falls within, i.e. is comprised within, the reflection region 820 of the DM 154. This ensures that light emitted by the LED 110 of the LED module is reflected by the DM 154. The cross-over point 840, i.e. the wavelength at which light is transmitted and reflected at approximately equal percentages, is just above 470 nm.

The control components 113 may also comprise a thermistor for monitoring the substrate temperature. This allows the controller PCB to instruct the LED module to shut down if the substrate temperature becomes too high. The LED module control components 113 may also comprise a photodiode. This allows the light output of the LED to be monitored. The photodiode's simplest purpose will be to determine/detect that the LED light is on or off. This feature allows confirmation that the LED is working and not just conducting current as in the case of a damaged LED. This is a self-monitoring feature valuable to equipment manufacturers. In a more complex form the photodiode can be used to precisely control light output by using optical feedback from the photodiode. In this case a value from the photodiode can be monitored by the CPU on the controller PCB. A constant value within a given tolerance can then be maintained from the photodiode electronically, by the controller modifying current to the LED and thus controlling light output at a constant level.

The substrate 112 is shaped and configured to be attached to an LED module 100 such that the LED 110 may emit light into the LED module 100. In the illustrated embodiment, the substrate 112 is clamped to the LED module housing by two bars 116 which are fixed into place using an arrangement of screws 117. The substrate 112 also comprises an extending region 119 that extends beyond the module block when the substrate is attached to the LED module housing. This extending region 119 allows the module to be precisely positioned during assembly, for example to ensure the LED is located centrally within the bore of the LED module 100.

It has been found that bonding a bare, unpackaged LED directly to the substrate has advantageous thermal properties. The base of the substrate 112 is in turn in contact with a heatsink 120. The heat sink may have a fan directly attached, which is configured to direct air onto the heat sink to remove heat. Alternatively, a fan that is not attached to the heatsink but which directs air through a suitable channel or arrangement of channels may be used to help cool a number of heat sinks, for example in an arrangement comprising multiple LED modules. The purpose of the heatsink 120 is to transfer heat generated by the LED and/or its associated electronics away from the LED 110 and the LED module 100. While the LED, substrate and heat sink have been described as separate elements, the LED substrate and heat sink may be combined into a single component in order to improve thermal management.

The operation of an LED module 100 will now be described. A controller, or controller PCB, controls the operation of the LED module 100. The controller sends a control signal to a driver, or driver PCB. The control signal may indicate which LED modules should be turned on, and for how long. Upon receiving the control signal, the driver sends a drive signal to the LED module based on the control signal. In other words, the controller PCB is configured to provide control signals to each driver PCB coupled to it to control which drive signals are sent to which LED module. When the drive electronics of a particular LED module 100 receive a drive signal from a driver PCB, the LED 110 is switched on and begins to emit light. As will be appreciated by the skilled person, the drive signal may comprise a switching signal and hence the LED 110 may be turned on and off very quickly at a high switching frequency. The electronics may comprise a controller such as a controller PCB board and a driver such as a driver PCB board. Suitable arrangements for drive and control electronics are described in greater detail below.

The light generated by the LED 110 is emitted inside the housing in a direction toward the light director 154 and along the central axis of the bore. The light is collected and collimated by the light collector 130. If an excitation filter 145 is positioned in the filter slot 140, then the light is filtered as it passes through the excitation filter 145. The filtered, collimated light continues to travel through the bore until it passes through the first aperture 152 and into the DM block 150. The light is incident on the DM 154, and is reflected through an angle of substantially 90° to pass through the third aperture 156. Light exits the third aperture 156 at an angle substantially normal to the third aperture 156.

The resulting single collimated light beam has a specific wavelength or comprises light of a narrow band or range of wavelengths. This specific wavelength or range of wavelengths may be described as a wavelength ‘channel’.

In use as part of a light source in a fluorescence microscopy application, light exiting an LED module 100, or an array of LED modules, is passed to an optical output module. Suitable output modules are described below.

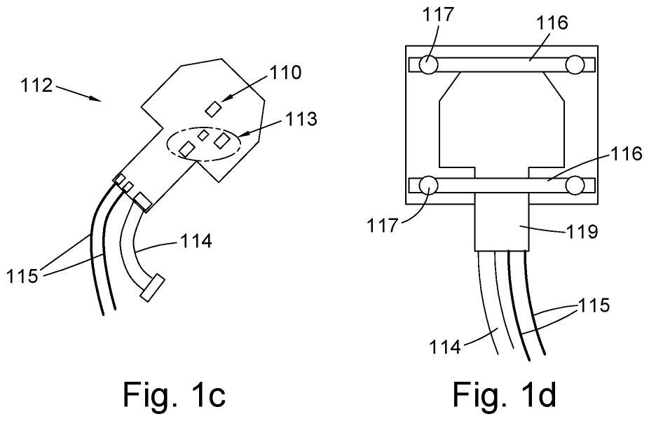

The LED modules of the present disclosure may be arranged in a number of ways. FIGS. 2a and 2b are schematic diagrams which show two such arrangements.

FIG. 2a depicts four LED modules 202a-d which together form a light source arrangement 200a. The light source arrangement 200a can provide a plurality of wavelength channels for use in the field of fluorescence microscopy. Each LED module 202 provides a respective wavelength channel by being configured to produce light of a respective wavelength or wavelength range, as determined by the choice of LED 210 and/or excitation filter 245. Each respective LED module comprises an LED 210 and a light director 254 for directing light emitted by the LED 210. The LED modules 202a-d in the arrangement are optically aligned, and together form a planar array of LED modules. In other words, the LED modules 202a-d are positioned adjacent to one another, front-to-back, and are aligned such that light exiting from each respective module is parallel with light exiting from the other modules. This arrangement may be described as a ‘stacked’ arrangement.

In more detail, a first LED module 202a has a first LED 210a. Light emitted by the first LED 210a travels in a first direction from the LED 210a toward the light director 254a, along a first optical path 201a. The first optical path 210a is either along, or is substantially parallel with, the central axis of the bore of the first LED module 202a. Light travelling along the first optical path 201a may pass through a first light collector 230a and a first excitation filter 245a, and is incident on a first light director 254a.

Light emitted within the second LED module 202b, and the third and fourth LED modules (202c, 202d), travels in the first direction along similar respective optical paths (201b, 201c, 201d). These optical paths (201a, 201b, 201c, 201d) are substantially parallel to one another. Light is reflected and hence re-directed at each respective light director (254a-d) such that the light exiting each LED module (202a-d) is directed in a second direction, substantially perpendicular to the first direction, and along an optical axis 270. Light emitted by a particular LED module in the stack passes along the optical axis 270 and through the apertures and dichroic mirrors of any LED modules located in front of it. An optical axis can be described as a straight line which passes through the light directors of a number of LED modules. The respective dichromatic mirrors 254 (a-d) are each configured to reflect the light emitted by the LED with which the dichromatic mirror shares a housing, but to pass or transmit light emitted by LEDs from LED modules behind it in the arrangement. To ensure that light emitted by the LEDs 210(a-d) of each LED module 202(a-d) is directed in the same direction and along the same optical axis 270, the light directors of each of the plurality of LED modules (210(a-d) are optically aligned along the optical axis 270. Light which exits the arrangement 200a may thus comprise wavelength regions associated with any number of the LEDs 210(a-d) comprised within the arrangement.

Each LED module is individually removable from, and re-attachable to, the support structure. This allows particular modules to be easily swapped in and out, for example for maintenance, repair, or to introduce a particular wavelength channel. The arrangements described herein therefore comprise at least one removable Led module, and preferably every module is individually attachable and detachable.

Innovative design rules are imposed on the stacked arrangement of FIG. 2a. These design rules produce an arrangement in which the complexity of adding or removing a wavelength channel to a light source arrangement is vastly reduced. By a suitable ordering of LED modules 202a-d in the arrangement/stack, light produced by each LED module will pass through the DM block of any LED module in front of it in the stack. The dichromatic mirrors are long-wavelength-pass dichromatic mirrors. Such mirrors have a ‘cross-over’ wavelength, or cross-over wavelength region, below which light is reflected, and above which light is passed, or transmitted. The dichromatic mirrors of LED modules 202a-d each have respective cross-over points above the emission wavelength of the LED 210a-d in the housing they are attached to. In a preferred embodiment, the DM 254a of a particular LED module 202a has a cross-over point just above, i.e. close to, the wavelength of the LED 210a comprised within that LED module 202a.

The cross-over region on a dichromatic mirror describes the wavelength region where the DM changes from reflecting light to transmitting light. The steepness of this transition region i.e. moving from reflection to transmission has an impact on how tightly wavelengths can be combined, however shorter transition regions are more expensive. A cross-over region of around 20 nm can be obtained at reasonable prices and this means that two LED emission peaks one at say 400 nm and another at 420 nm can be combined without reducing power at the LED wavelength peak. 20 nm cross-over regions are considered sufficiently good for combining LEDs with close peaks in this application.

The transmission and reflection properties of a dichromatic mirror according to this arrangement are depicted in FIG. 8. The LED 110 of the LED module depicted in FIG. 8 emits light at an emission wavelength 810, in the depicted example the emission wavelength is equal to or substantially equal to 470 nm. The DM block of the LED module comprises a dichroic mirror 154 having the transmission properties depicted in the graph. The graph shows percentage transmission as a function of wavelength. As will be appreciated, the LED emission wavelength falls within, i.e. is comprised within, the reflection region 820 of the DM 154. This ensures that light emitted by the LED 110 of the LED module is reflected by the DM 154. The cross-over point 840, i.e. the wavelength at which light is transmitted and reflected at approximately equal percentages, is just above 470 nm.

Following these rules, i.e. that the LED emission wavelength of each respective module should fall within a reflection region of the DM which shares a housing with the LED, and that the cross-over point should be above, i.e. greater than, and near to the LED emission wavelength peak, the arrangement of LEDs into the stacked arrangement depicted in FIG. 2a is made simple. The LED modules 201(a-d) simply need to be arranged in ascending order of wavelength. With reference to FIG. 2a, the LED 210b of module 202b must emit light at a higher wavelength than the LED 210a of module 202a. The LED 210c of module 202c must emit light at a higher wavelength than the LED 210b of module 202b, and so forth. These rules allow any number of LED modules to be stacked together to form an arrangement according to the present disclosure. It will also be appreciated that the transmission region 830 of each DM should extend far enough such that the wavelengths of the other LED modules ‘behind’ it in the stack fall within the transmission region. With this arrangement, modules of any wavelength can simply be swapped in and out, providing they are arranged in ascending order of wavelength.

It will be appreciated that, in another implementation, each LED module may comprise a short-pass DM rather than a long-pass DM. In this implementation, a modified rule set may be followed, and in particular that the LED emission wavelength of each respective module should fall within a reflection region of the DM which shares a housing with the LED, and that the cross-over point should be below, i.e. lower than, and near to the LED emission wavelength peak. Thus the arrangement of LED modules in a stack or other arrangement can be greatly simplified.

FIG. 2b shows another possible arrangement 200b of LED modules. This arrangement makes use of the detachable nature of the DM blocks of the LED modules.

This arrangement is beneficial due to the overall reduction in the number of interactions between the light and dichromatic mirrors. Light emitted by any LED 210 (e-h) must pass through at most two dichromatic mirrors. This reduces attenuation of light inside the light source arrangement 200b. The detachable nature of the dichromatic mirror block is utilised and three detachable dichromatic mirror blocks 250 (e-g) are shared between four LED primary blocks 205 (e-h). The LED modules 202e-h are arranged in the same plane. A first LED module 202e is configured to emit light in a first direction. The light is reflected by the DM of the first DM block 250e, which is attached to the first primary block 205e. The light is then reflected again by another DM block 205f along a direction indicated by the arrow in FIG. 2b and along a first optical axis 270. Light emitted by each of LED modules e-h The light paths of each of the LED modules 202f, g and h will be clear to the skilled person from the figure and hence need not be described in detail.

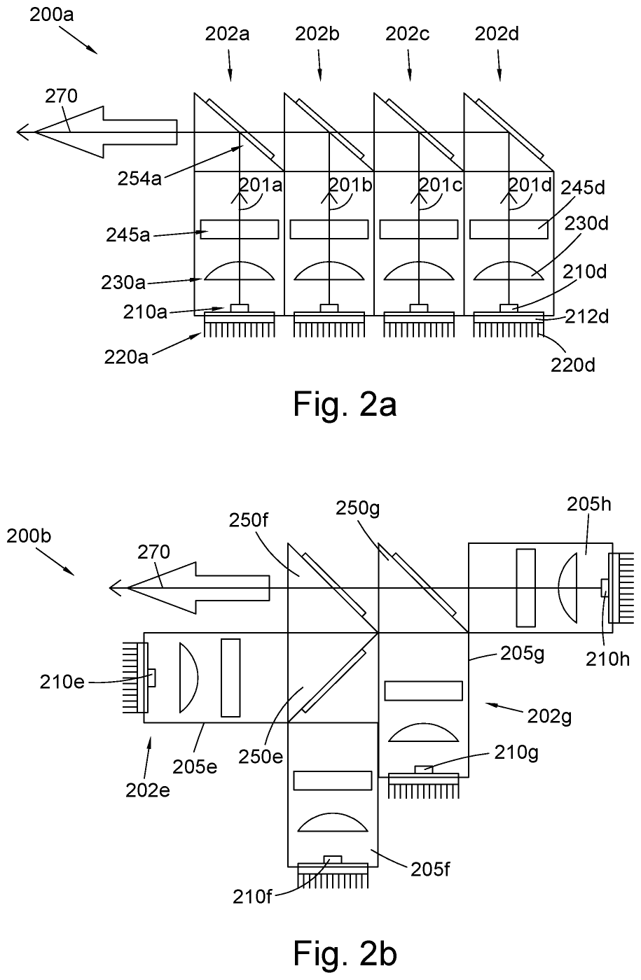

FIG. 3 shows a light source apparatus 300 suitable for use in fluorescence microscopy. The apparatus 300 comprises a plurality of LED modules (302a-d) in a ‘stacked’ arrangement as depicted in FIG. 2a and as described above.

The light source apparatus 300 further comprises an optical output module 380. The optical output module 380 is optically coupled to the third aperture of LED module 302a, i.e. to the aperture through which light exits LED module 302a. The light directors of each LED module 302(a-d) and the relevant apertures of each LED module 302(a-d) are aligned along an optical axis 370. The optical output module 380 is also optically aligned along the first optical axis 370 such that light exiting from any particular LED module passes through the apertures and light directors of any intervening LED modules and enters the output optical module. The optical output module 380 may comprise a lens. Light passed along the first optical axis and into the optical output module is in turn passed to a suitable arrangement of optics (not shown) which may focus light into an epi-fluorescent port of a microscope, or into a liquid light guide or fibre optic, as the application requires.

The optical output module 380 may be described as a final module that contains the optics for directing light produced by the LED modules into a microscope or light guide. Exemplary types of output module include an output module suitable for directing light into a microscope. This optical output module includes an optical adjustment to accommodate a wide range of microscopes. The optical output module may alternatively or additionally be configured to direct light into a liquid light guide. A 3 mm core liquid filled light guide is a typical method of delivering light from a light source to the microscope. The benefit over the direct attachment method is that the heat, weight and vibration from the light source is removed from the scope. The optical output module may alternatively or additionally be configured to direct light into an optical fibre. This allows for a wide range of applications in which light from the light source arrangement is not necessarily being directed to or through the microscope. Suitable optical output modules may be attached to the support component and can be easily swappable by the end user.

The light source apparatus 300 further comprises a driver PCB 390 and a controller PCB 395. The driver PCB 390 is communicatively coupled to each respective LED of the plurality of LED modules 302a-d. The controller PCB 395 is communicatively coupled to the driver PCB 390. In the embodiment depicted in FIG. 3, the controller PCB 395 is coupled to driver PCB 390 via a connector 396, however other suitable connection means may be used. The connector 396 is a protrusion, or extension, which extends from the control PCB 395, and may be a ‘RAM’ style connector. Alternatively, the connector may take the form of a ribbon cable. The driver PCB 390 comprises a corresponding slot which is configured to accept the connector 396. The slot and connector comprise conductive material, and connect to one another in a manner such that the PCBs are structurally and communicatively, e.g. electrically, coupled to one another.

As shown in FIG. 3, the controller PCB 395 may have a plurality of connectors 396 which allow the connection of a plurality of respective driver PCBs 390. The controller PCB shown in FIG. 3 has four connectors 396, two on each side of the controller PCB 395. Each of the plurality of driver PCBs 390 can be plugged into a connector 396 as required.

Electronic control and communication takes place in the Controller PCB 395.

The driver PCB 390 is configured to be controlled by the controller PCB 395, and contains suitable electronics to provide respective drive signals to the LEDs of each LED module 302a-d. The controller PCB 395 is configured to provide control signals to the driver PCB 390. As will be detailed later, the control PCB comprises a processor such as a CPU. The CPU contains instructions which, when executed, cause the controller PCB to provide a control signal to the driver PCB 390, which in turn provides a drive signal to one or more of the LEDs of LED modules 302a-d.

In an embodiment, each LED module may comprise cables to electrically connect it with the Driver PCB 390. One small ribbon cable will accommodate the control signals whilst two copper wires will deliver the power to drive the LED in each module. The cables will attach to a copper substrate on the module. In another embodiment connectors capable of conducting sufficient current can be used whilst also having enough pins to accommodate digital control signals. Such a connector on the LAM module and driver PCB can be connected by a suitable ribbon cable.

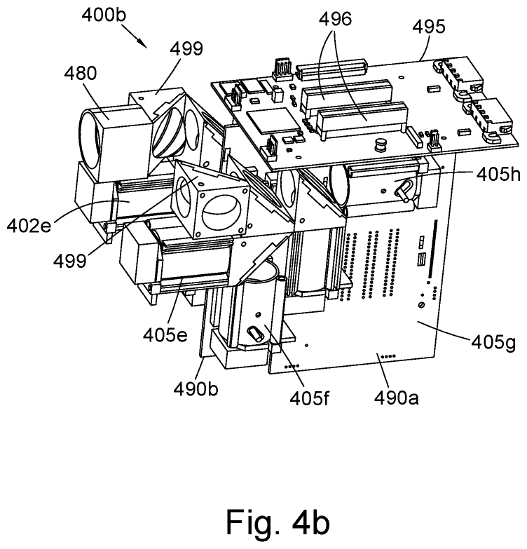

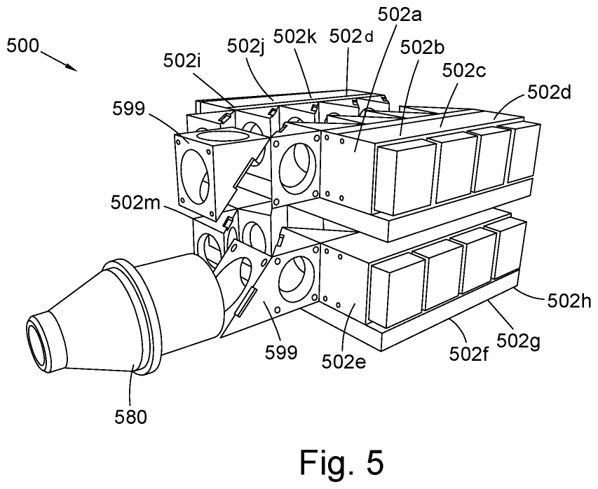

A diagram depicting suitable electronics for the operation and configuration of the driver PCB 395 is given in FIG. 6, and diagram depicting suitable electronics for the operation and configuration of the control PCB 390 is given in FIG. 7. The electronics depicted in these diagrams will be discussed in greater detail below.

The PCBs and LED modules can be held together via support structure (not shown in the figures). The support structure may comprise connecting plates connected together to create a frame for holding the LED modules and the connecting elements, e.g. the PCBs, together. These connecting plates may be made of a rigid and solid material, for example a metal such as aluminium, to provide structure and support. In more detail, the support structure may be made up of laser cut sheets of 3 mm thick aluminium that can be attached to each other to build up different frame arrangements. This is a low-cost method that offers lots of design flexibility whilst being sufficiently strong and rigid.

The support component and LED modules may comprise suitably configured and positioned tapped holes, allowing the LED modules to be screwed into place and in the chosen configuration, e.g. the ‘stacked’ configuration shown in FIG. 3, on a connecting plate.

The support component or frame is also used to hold the PCBs together. It is preferable for the driver PCB 390 to be positioned in proximity to the modules 302 (a-d). It is further preferably for the driver PCB 390 to be positioned adjacent to the driver PCBs 302(a-d). This reduces the length of cabling needed between the modules 302(a-d) and driver PCB 390 and so improves the reliability of the cable for fast power delivery and communications. Also, placing the driver PCB 390 against a support component comprising a conducting metal such as aluminium means that the support component/support frame has a secondary use as a heatsink, as some of the drive electronics can get hot during operation.

In a preferred embodiment, the driver PCB 390 is positioned adjacent to the support component.

The modules 302 (a-d) can be easily attached, removed, and re-attached to the support frame using an arrangement of screws and tapped holes.

FIG. 6 depicts the features of a controller PCB 395 in accordance with the present disclosure. The arrows between features depict communicative and electronic couplings between the PCB features.

The controller PCB 395 comprises a central processing unit (CPU) 602. The CPU 602 is coupled to a computer-readable medium, for example a non-transitory computer-readable medium. The computer readable-medium is preferably a read-only memory such as an EEPROM chip 610. The computer-readable medium carries computer-readable instructions arranged for execution upon the CPU 602 or other processor so as to make the CPU 602 carry out any or all of the methods described herein, and perform the functionality described herein.

The term “computer-readable medium” as used herein refers to any medium that stores data and/or instructions for causing a processor to operate in a specific manner. Such storage medium may comprise non-volatile media and/or volatile media. Non-volatile media may include, for example, optical or magnetic disks. Volatile media may include dynamic memory. Exemplary forms of storage medium include, a floppy disk, a flexible disk, a hard disk, a solid-state drive, a magnetic tape, or any other magnetic data storage medium, a CD-ROM, any other optical data storage medium, any physical medium with one or more patterns of holes, a RAM, a PROM, an EPROM, a FLASH-EPROM, NVRAM, and any other memory chip or cartridge. Data may be transferred between the CPU 602 and EEPROM chip 610 by a bus such as an SPI.

The controller PCB comprises a power connector 604 configured to connect to an external power supply. The external power supply powers the electronics and the LED modules. The power connector 604 may be a PSU and is rated to cover the electrical requirements of a given number of LED Modules based on the end application requirements. A power regulator 606 is used to ensure the voltage is kept to acceptable limits. The voltage regulator ensures that regulated voltage is provided to the controller and driver PCBs.

The controller PCB also comprises at least one, and preferably a plurality, of connectors for driver PCBs as discussed herein. The connectors may be described as module slots 630. The module slots 630 may each be configured to allow connection of a driver PCB to the controller PCB. The module slots may be edge connectors which connect to respective driver PCBs. The connection may be via a suitably configured male/female connection.

The CPU 602 is coupled to a module which allows instructions and new data to be provided to the controller PCB 395 over the internet, such as a WIFI module 618. The WIFI module 618 also allows the controller to transmit data about itself or the apparatus, for example diagnostic data about a particular LED module. Similarly, the controller may comprise a USB port 616 which allows for boot loading and external communication.

The USB is for external communication to a PC for controlling the light source, for example from third party software imaging packages. These packages can control all microscope elements. The WIFI allows remote control but in a similar way to USB control. The external connector module 640 allow a hardware interface for LED control such as from a function generator. The external connection module 640 allows the PCB to be connected to TTL and may provide an analog in/out.

The controller PCB may also comprise a board indication element 650 such as dual colour LED to indicate PCB states, i.e. if a PCB is operating under normal operation conditions or is faulty.

FIG. 7 depicts the features of a driver PCB 390 in accordance with the present disclosure. The driver PCB 390 may comprise a CPU 702, though this is not essential as would be understood by the skilled person.

The driver PCB 390 comprises a substrate connection 714 for connection to the substrates of one or a plurality of LED modules. In one embodiment, each LED module is connected to a driver PCB 390 using a number of cables. The driver PCB 390 may comprise the cables and/or the LED modules may comprise the cables. The control components of each respective LED module are described elsewhere herein.

LED based light sources have several benefits over the traditional bulbs used in fluorescence microscopy. LEDs have much longer lifetimes, reduced maintenance requirements, reduced energy usage, allowed faster imaging, and improve research through improving signal-to-noise ratio and, through their faster switching capability, LEDs can also improve cell-viability and reduce photobleaching in samples.

It will be appreciated that the light source apparatuses described herein have several benefits over known devices. Known devices often provide an end user with a complex and confusing arrangement of LEDs, optics, and electronics. These complex arrangements mean that the ability of an end-user to modify the apparatus, for example to add or remove an LED wavelength channel, is hindered. Given the structural complexity of previous device, an end-user is also less able to both diagnose and also to fix potential problems which may arise when operating the light source apparatus, for example the misalignment of a particular optical component.

The present light source apparatus addresses these problems and others by providing a modular LED solution with increased structural simplicity. The LED modules each comprise housing enclosing the LED and to which the light director can be attached. The provision of discrete LED modules in this manner provides increased simplicity of assembly and manufacture, as well as providing efficiencies in manufacture because the need to manufacture several different and disparate components is reduced.

A manufacturer can provide a light source apparatus according to the present disclosure which has any number of LED channels simply by adding or removing LED modules from the arrangement, preferably according to the ordered arrangement described above in relation to FIG. 8. Similarly, an end-user may modify a light source apparatus according to the present disclosure by adding or removing LED modules from the arrangement.

By providing a light source apparatus having at least one LED module which may be removed and re-attached to the support structure, an adjustable number of wavelengths can be provided. Providing driver PCBs each configured to provide drive signals to LED modules, and having each of these driver PCBS coupled to a controller PCB, means that multiple LED modules can be attached, added, and removed from the apparatus to provide a scalable and modular LED assembly. Having a central controller PCB, which may e.g. have the components required for external connection, receive updates from a WIDI module and to receive power from an external power connection, and which provides control signals to each of the driver PCBs creates a space efficient solution which

The current prevailing opinion in the industry is that light source devices/apparatus should be sold which provide a set number of wavelength channels suitable for fluorescence microscopy, for example those channels which are in common use in the field of fluorescence microscopy. The present inventor has realised that the known prior approaches are short-sighted, in particular give that the fluorescence microscopy field is progressing toward using higher and higher wavelength light sources, for example into the IR region. In view of this trend, end-users are finding that products that were designed for the most popular and common wavelengths several years ago now find that the light source apparatus they have bought limits the extent of their research. These known devices do not provide a modular, scalable design solution as provided for by arrangements of the present disclosure. Design times are also reduced as LED modules with different LEDs at different wavelengths simply need to be added or swapped in to replace the existing LED modules.

Presently disclosed light source apparatus use a modular and scalable approach and comprise LED ‘modules’. Incorporating features such as a dichromatic mirror and an LED, as well as optional features such as an excitation filter and a collection lens, as part of a single LED module significantly reduces space requirements, as well as manufacturing and assembly complexity. Providing these features within, or attached to, a single shared block or a common housing is also beneficial for similar reasons.

The benefits to the manufacturer of light sources for this market will be reduced costs and reduced time to market for targeted application specific products. Cost reduction will be realised by the modular approach being capable of addressing all application specific light source products with wavelength channel requirements ranging from one to sixteen. Although the manufacturer may offer a range of products, two wavelength, five wavelength, nine wavelength, the same building blocks can be used across all products thus gain from economies of scale and reduce complexity and variety of parts in manufacturing.

When a new application in fluorescence microscopy emerges or a standard application develops by requiring a new wavelength or an additional wavelength the modifications necessary in design will be minimised and the new solution can be made available very quickly to the target market.

Using the same types of components for each LED module, for example the same type of housing, light director, light collector and adjustment means for each LED module, allows for significant manufacturing efficiencies. Additionally, as each LED module may use the same type of light collector, or collector lenses, regardless of LED wavelength, the process of achieving collimated light can be simplified. The adjustment means allows the positions of the collector lenses for a particular LED module to be adjusted relative to the LED. Therefore to achieve collimation of each LED module a user simply needs to adjust each adjustment means. Providing such LED modules vastly simplifies the process of achieving collimated light from each LED. This is particularly important in a system as disclosed in which a manufacturer or user can simply add a new LED module and hence wavelength channel.

More generally, as LEDs are controlled electronically they can be switched on and off much faster than mechanical shutters, so helping control excessive light exposure to the sample and save the user the cost of high speed shutters. Excitation filter wheels are also made redundant with LED sources as excitation filters can be placed in front of the LED and remain fixed. Simply switching off one LED and switching on another provides much higher speed colour switching than is available from the fastest excitation filter wheels.

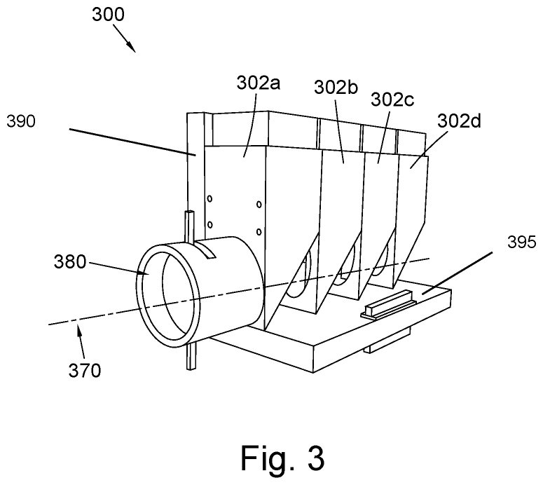

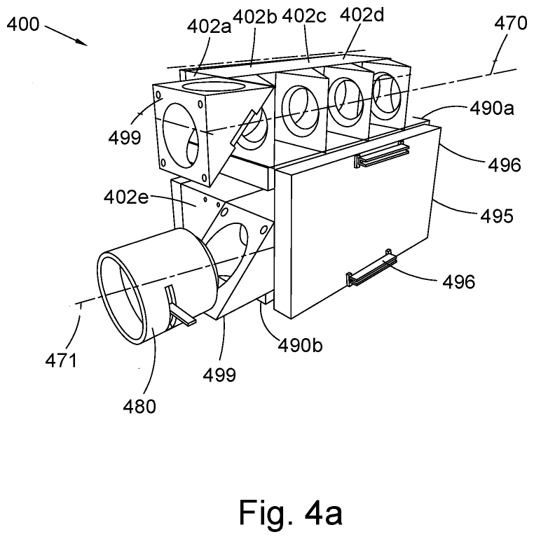

FIGS. 4a, 4b and 5 depict embodiments of the light source apparatus in which, in addition to a first plurality of LED modules, there is also provided at least a second plurality of LED modules, and in the embodiment of FIG. 5 also a third and fourth plurality of LED modules.

Increasing the number of optical components through which light at a particular wavelength must pass reduces the intensity/power of light. The embodiments of FIGS. 4 and 5 reduce the number of optical components through which light emitted by an average LED must pass, and thereby these embodiments are able to reduce light attenuation and provide improved power efficiency.

FIG. 4a shows a light source apparatus 400a. In much the same way as the apparatus 300 shown in FIG. 3, the light source apparatus comprises a first plurality of LED modules 402(a-d) attached to support structure (not shown in the figures for increased clarity) and coupled to a driver PCB 490(a). Driver PCB 490(a) is structurally and electronically coupled to a controller PCB 495 via a connector 496. These components operate in the same manner described above in relation to FIG. 3.

The light source apparatus 400 depicted in FIG. 4a additionally comprises a second plurality of LED modules, of which LED module 402(e) can be seen in FIG. 4a. The second plurality of LED modules are attached to the support structure and are also coupled to a second driver PCB 490(b). In other words, the first plurality of LED modules is associated with first driver PCB 490(a) and the second plurality of LED modules is associated with the second driver PCB 490(b). The second driver PCB 490(b) is structurally and electronically coupled to the controller PCB 495 via a connector 496. The driver PCBs 490 (a) and 490 (b) share a common controller PCB 495, and are each attached to the controller PCB 495 via one of a plurality of connectors 496.

The light directors of the LED modules which form the first plurality of LED modules are optically aligned along a first optical axis 470, and the light directors of the LED modules which form the second plurality of LED modules are optically aligned along a second optical axis 471. In other words, the first plurality of LED modules 402a-d are arranged in a first arrangement in a first plane, and the second plurality of LED modules 402e-h are arranged in a second plane. In the arrangement of FIG. 4a, the planes are parallel to one another. Light emitted by any LED module of either the first or second plurality of LED modules is directed by its respective light director in a direction toward the output module 480, however the first and second optical axes 470 and 471 are spatially separated. Providing multiple pluralities of LED modules with spatially separated optical axes makes more efficient use of space and minimises the number of dichromatic mirrors through which light must pass when compared to an arrangement with an equal number of LED modules aligned along a single optical axis.

An additional arrangement of optics may be required in order that light from both the first and second pluralities of LED modules passes into the output module 480. In FIG. 4a, the additional arrangement of optics is provided by two additional light directors, in this case dichromatic mirrors 499.

Turning to FIG. 4b, this figure also shows a light source apparatus 400b comprising two pluralities of LED modules, each arrangement arranged in a different plane. The arrangements correspond with that shown in FIG. 2b and need not be explained in further detail here. As with the apparatus 400a shown in FIG. 4a, each LED module arrangement has its own driver PCB 490(a,b) to provide drive signals to the LEDs/LED modules of that arrangement. Each driver PCB 490 (a,b) is attached to a shared control PCB 495 configured to provide control signals to the drive PCBs 405 (a,b)

FIG. 5 depicts a light source apparatus 500 comprising multiple pluralities of LED modules. Specifically, in the embodiment depicted, the apparatus comprises four different arrangements of LED modules, with each arrangement comprising 4 LED modules. The apparatus shares features and functionality with the above described embodiments. The multiple pluralities comprise a first plurality of LED modules 502 (a-d) attached to a support structure in a first arrangement, a second plurality of LED modules 502 (e-h) attached to the support structure in a second arrangement, and a third and fourth plurality of LED modules 502 (i-l) and (m-p—not all shown in FIG. 5) attached to the support structure in respective third and fourth arrangements. The light directors of every module are arranged such that light emitted by every LED comprised within the multiple pluralities of LEDs is directed in a single direction, toward the light output module 580. The light directors of the LED modules in each respective arrangement are optically aligned along respective optical axes to form multiple optical axes, i.e. to form first, second, third and fourth optical axes. Light emitted by the first, second, third and fourth arrangements of LED modules is directed so as to travel along the first, second, third and fourth optical axes.

As with the light source apparatus depicted in FIGS. 4a and 4b, an additional arrangement of optics 599 may be required in order that light from the multiple arrangements of LED modules passes into the output module 580.

It will be understood that the above description of specific embodiments is by way of example only and is not intended to limit the scope of the present disclosure. Many modifications of the described embodiments, some of which are now described, are envisaged and intended to be within the scope of the present disclosure.

For example, while each plurality of LED modules is shown to comprise four LED modules in the figures, it will be appreciated that there may be any number of LED modules comprised within each plurality.

The driver PCBs have been described as being connectable to the individual LED modules by cables and/or wires. However, in an alternative embodiment, the driver PCBs comprise electrical contacts. The electrical contacts allow simple and easy coupling. The provision of electrical contacts is particularly beneficial in an embodiment wherein the support structure comprises attachment means such as guiding/interlocking grooves and/or slots which are configured to interact with corresponding grooves and/or slots on the housing of each LED module. Together these features form an interlocking mechanism which removes the need for both screws and tapped holes as well as the need for an arrangement of wires and/or cables. Such a mechanism could be fabricated as a ‘click-and-connect’ mechanism. In such an embodiment an end-user may simple slide out a particular LED module and slide in another LED module. Upon sliding in an LED module, contacts on the driver PCB and the housing of the LED module electrically connect, removing the need for wires and reducing complexity in assembly.

In this embodiment, the support structure could comprise injection moulded plastic parts. The LED modules could also comprise injection moulded plastic. In this case all internal mechanical parts could be made from a plastic material with the outer box made from metal to reduce electromagnetic radiation. An electrical contact is formed on the substrate of the LED modules, which could connect with a corresponding contact on the driver PCB. Another option is to have a connector on the LAM module that makes contact with the driver PCB.

Reference is made herein to attachment means, for example screws and tapped holes and/or guiding interlocking grooves or the like. The attachment means may also be referred to as “attachers” or “attachment structure”, which is comprised on either the support structure, each LED module, or with corresponding structure on both the support structure and LED modules.

The LED module may be fabricated in a number of ways. FIG. 9 shows an extrusion 900 suitable for forming an LED module, and FIG. 10 depicts part of the fabrication process. To form the extrusion, an extruded piece of metal of suitable dimensions is cut to the required length. A bore is formed in the bar. A suitable metal is aluminium. A collector lens assembly can then be inserted into the bore. A slot can be machined in the extrusion to allow the fitting of an excitation filter, for example a 25 mm diameter excitation filter. An angled surface is formed by cutting the extrusion at 45 degrees to the central axis of the bore. The angled surface will form the angled face 151 which will hold the dichromatic mirror as discussed in detail above. The DM block can be formed by cutting the extrusion at an angle perpendicular to the bore central axis.

Alternatively, the LED module could be comprised of plastic, which may be injection moulded. In both cases the module is cut to form the separate DM block and primary block, and optical components can be simply glued into place during production.

The skilled person will appreciate, given the above description, that the method of manufacture of LED modules and the support structure they attach to may comprise a number of methods and materials, for example machined aluminium or other metal, extruded metal, extruded metal that is machined, plastic that is injection moulded, plastic or metal or another material that is 3-D printed.

While reference is made herein to terms such as “upper”, “lower”, “top”, “bottom”, “base”, and other terms which imply a particular orientation, it will be appreciated that these terms are made with reference to the figures and are to assist the skilled person in obtaining an understanding of the invention. These terms should not be construed as illustrative rather than limiting or restrictive.

Some examples of the light source apparatus disclosed herein may be described as follows: a light source apparatus for providing an adjustable number of wavelength channels for use in the field of fluorescence microscopy is provided. The light source apparatus comprises a plurality of LED modules, each respective LED module comprising a housing enclosing an LED and a light director attachable to said housing for directing light emitted by the LED.

The plurality of LED modules are attached to a support structure via attachment means in a first arrangement, wherein, in the first arrangement, light emitted by each LED is directed along a first optical axis. At least one LED module of the plurality of LED modules is a removable LED module, the attachment means being configured to allow the removal and re-attachment of the removable LED module to and from the first arrangement.

Some examples of the light source apparatus disclosed herein may be described as follows: a light source apparatus for providing an adjustable number of wavelength channels for use in the field of fluorescence microscopy is provided. The light source apparatus comprises a plurality of LED modules, each respective LED module comprising an LED and a light director for directing light emitted by the LED. The light source apparatus further comprises a support component, or support structure, comprising attachment means configured for the attachment of the plurality of LED modules to the support component in a first arrangement, wherein, in the first arrangement, the light directors of each of the plurality of LED modules are optically aligned along a first optical axis. The plurality of LED modules comprises a removable LED module, the attachment means being configured to allow the removal and re-attachment of the removable LED module.

The above implementations have been described by way of example only, and the described implementations and arrangements are to be considered in all respects only as illustrative and not restrictive. In particular, while the description refers to fluorescence microscopy including high Content screening applications, it is recognised that the described invention can also be applied to spectroscopy work in general where spectrally engineered light from LED based sources is desired. This includes automated setups such as in machine vision. It will be appreciated that variations of the described implementations and arrangements may be made without departing from the scope of the invention.

1-23. (canceled)

24. A light source apparatus for providing an adjustable number of wavelength channels, the light source apparatus comprising:
at least a first plurality of LED modules, each LED module comprising an LED, a housing which at least partially encloses the LED, and a light director attachable to said housing for directing light emitted by the LED;
the first plurality of LED modules being attached to a support structure in a first arrangement via attachment means; wherein, in the first arrangement, light emitted by each LED of the first plurality of LEDs is directed along a first optical axis; and
the light source apparatus further comprising a plurality of driver PCBs and a controller PCB, each driver PCB of the plurality of driver PCBs being coupled to the controller PCB, and each LED module of the first plurality of LED modules being coupled to a first driver PCB of the plurality of driver PCBs;
wherein the controller PCB is configured to provide control signals to each of the driver PCBs, and wherein each driver PCB is configured to provide drive signals to any LED module coupled with it.

25. The light source apparatus of claim 24, wherein in the first arrangement the light directors of each of the plurality of LED modules are optically aligned along the first optical axis.

26. The light source apparatus of claim 24, the housing of each LED module further enclosing one or more of: a light collector comprising a collecting lens, an excitation filter, and means to adjust relative distance between the LED and the collecting lens.

27. The light source apparatus of claim 24, further comprising a light output module into which light emitted by each LED is directed.

28. The light source apparatus of claim 24, the housing of each LED module further comprising the attachment means.

29. The light source apparatus of claim 24, wherein the light director is removably attached to the housing.

30. The light source apparatus of claim 24, wherein each respective light director is a dichromatic mirror, and
wherein each LED is configured to emit light at a different emission wavelength, and each respective dichromatic mirror is configured to reflect light at the emission wavelength of the LED enclosed within the housing to which it is attached.

31. The light source apparatus of claim 30, wherein each respective dichromatic mirror is configured to pass light at wavelengths above an emission wavelength of the LED enclosed within the housing to which it is attached.

32. The light source apparatus of claim 30, each respective dichromatic mirror being configured to have a cross-over wavelength which is larger than the emission wavelength of the LED enclosed within the housing to which it is attached, the cross-over wavelength being the wavelength at which the dichromatic mirror reflects and transmits light at equal intensities, and
wherein the cross-over wavelength preferably falls within the range of 10 nm above the LED emission wavelength and 50 nm above the LED emission wavelength, and even more preferably falls within the range of 10 nm above the LED emission wavelength and 20 nm above the LED emission wavelength.

33. The light source apparatus of claim 31, each respective dichromatic mirror being configured to have a cross-over wavelength which is larger than the emission wavelength of the LED enclosed within the housing to which it is attached, the cross-over wavelength being the wavelength at which the dichromatic mirror reflects and transmits light at equal intensities, and
wherein the cross-over wavelength preferably falls within the range of 10 nm above the LED emission wavelength and 50 nm above the LED emission wavelength, and even more preferably falls within the range of 10 nm above the LED emission wavelength and 20 nm above the LED emission wavelength.

34. The light source apparatus of claim 24, wherein, in the first arrangement, the LED modules are arranged in increasing order of LED emission wavelength.

35. The light source apparatus of claim 24, wherein each LED module is a removable LED module such that each LED module is individually attachable and detachable to the support structure.

36. The light source apparatus of claim 24, wherein the control signals are indicative of which LED should be turned on, and optionally at what frequency a particular LED should be switched.

37. The light source apparatus of claim 24, further comprising a second plurality of LED modules attached to the support structure in a second arrangement, and
wherein in the second arrangement the light directors of each of the second plurality of LED modules are optically aligned along a second optical axis, and
wherein the first optical axis is spatially separated from the second optical axis.

38. The light source apparatus of claim 37, wherein the light directors of the first plurality of LED modules and the light directors of the second plurality of LED modules are configured to direct light emitted by the LEDs in a first direction.

39. The light source apparatus of claim 24, further comprising multiple pluralities of LED modules, each plurality of LED modules being coupled to a respective driver PCB, and each plurality of LED modules being attached to the support structure in a respective arrangement.

40. The light source apparatus of claim 39, wherein the light directors of the LED modules in each respective arrangement are optically aligned along respective optical axes, each optical axis being spatially separated from the other optical axes.

41. The light source apparatus of claim 24, wherein the light directors of each respective arrangement are configured to direct light emitted by the LEDs in their arrangement in a first direction.

42. The light source apparatus of claim 24 wherein at least one LED module of the first plurality of LED modules is a removable LED module, the attachment means being configured to allow the removal and re-attachment of the removable LED module to and from the first arrangement.

43. A method of manufacturing a light source apparatus, the method comprising:
providing at least a first plurality of LED modules, each respective LED module comprising a housing enclosing an LED and a light director attachable to said housing for directing light emitted by the LED;
attaching the first plurality of LED modules to a support structure in a first arrangement via attachment means such that light emitted by each LED is directed along a first optical axis; and
the method further comprising providing a plurality of driver PCBs including a first driver PCB, each driver PCB being configured to provide drive signals to LED modules coupled thereto;
coupling each LED module of the first plurality of LED modules to the first driver PCB; and
coupling each driver PCB of the plurality of driver PCBs to a controller PCB, the controller PCB being configured to provide control signals to each of the driver PCBs to control the drive signals sent to each LED module.
